(19) United States
(12) Patent Application Publication
(10) Pub. No.: US 2011/0102267 A1
(43) Pub. Date: May 5, 2011

(54) METHOD AND SYSTEM FOR DETERMINING LOCATION INFORMATION

(76) Inventors: Tom J. Janiszewski, Andover, NJ (US); Mauricio Cortes, Scotch Plains, NJ (US); John D. Hobby, Piscataway, NJ (US)

(21) Appl. No.: 12/609,181

(22) Filed: Oct. 30, 2009

(51) Int. Cl. G01S 3/02

(52) U.S. Cl. 342/463

(57) ABSTRACT

An exemplary method of determining location information includes transmitting a modeling signal from each of a plurality of detectors. Each of the plurality of detectors receives at least one of the transmitted modeling signals from the other detectors. At least one characteristic of each of the received modeling signals is determined. A signal propagation model for an area near each of the detectors is automatically determined based on the characteristic of each of the received modeling signals. The determined propagation model indicates an effect on a signal received within the corresponding area.

### BACKGROUND

There are various situations in which locating an object or an individual is desirable. For example, in a hospital setting it is useful to be able to determine the location of particular equipment. There are a variety of commercial or industrial settings in which determining the location of equipment or individuals is also useful.

There are a variety of technologies available for determining locations of objects or individuals. Global positioning system (GPS) arrangements provide accurate location information for many situations. One significant shortcoming of GPS arrangements is that the GPS receivers require a clear view of the sky. Such arrangements are not useful within closed buildings or other settings where sufficient satellite signals are not readily received.

Another example location technology is based on cellular telecommunications equipment. Such arrangements have a similar limitation in that base station signals may not be available at all positions where location information is desired. Additionally, devices capable of cellular telecommunications may be too expensive for some applications.

Other localization arrangements rely upon sensors or readers positioned about a location of interest. One drawback associated with most such arrangements is that they require manual mapping of radio signal strength. For example, an individual must manually move through the location of interest with equipment capable of measuring signal strength at many locations within the area of interest. This is a time-consuming and labor intensive process that introduces additional expense. A major shortcoming of such arrangements is that there is the possibility for changes within the environment that will alter the manually collected information. For example, the movement of individuals within an area may block signal transmissions at various times. Additionally, changes in a floor plan or a rearrangement of objects within an area can affect signal propagation in that area. It is impractical to manually update the signal propagation information for such arrangements.

### SUMMARY

An exemplary method of determining location information includes transmitting a modeling signal from each of a plurality of detectors. Each of the plurality of detectors receives at least one of the transmitted modeling signals from the other detectors. At least one characteristic of each of the received modeling signals is determined. A signal propagation model for an area near each of the detectors is automatically determined based on the characteristic of each of the received modeling signals. The determined propagation model indicates an effect on a signal received within the corresponding area.

An exemplary device for determining location information comprises a detector configured to transmit a modeling signal and receive the modeling signal from at least one other detector. The device includes a propagation modeling module that is configured to determine a signal propagation model for an area near the detector based on at least one characteristic of at least one modeling signal received by the detector. The propagation model indicates an effect on a signal received within the corresponding area.

The propagation model is automatically determined and automatically, periodically updated to compensate for any changes within the area of interest that would affect signal propagation in that area. The propagation model is useful for determining a location of a transmitter.

The various features and advantages of disclosed examples will become apparent to those skilled in the art from the following detailed description. The drawings that accompany the detailed description can be briefly described as follows.

### BRIEF DESCRIPTION OF THE DRAWINGS

FIG. 1 schematically illustrates a system for monitoring a location designed according to an embodiment of this invention.

FIG. 2 is a flowchart diagram summarizing an example approach.

FIG. 3 is a flowchart diagram summarizing another example approach.

### DETAILED DESCRIPTION

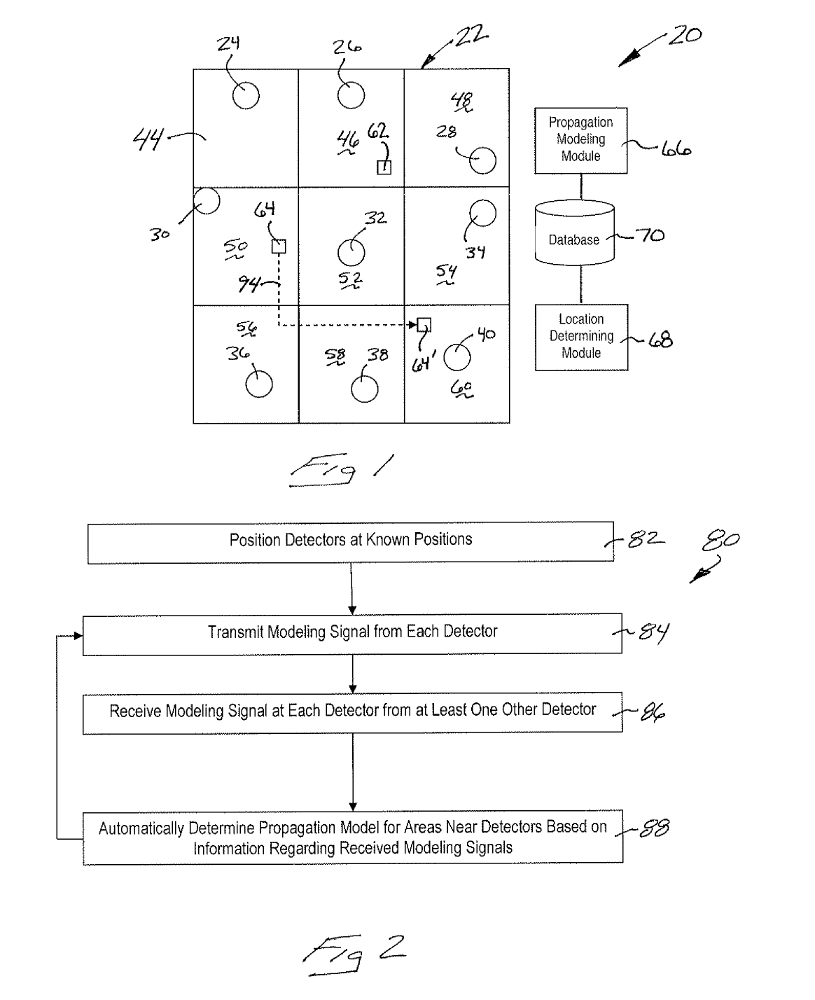

FIG. 1 schematically shows a system 20 for monitoring a site 22. A plurality of detectors 24, 26, 28, 30, 32, 34, 36, 38 and 40 are strategically positioned within the location 22. In this example, the site 22 is divided up into different areas of interest. In the illustrated example each detector is associated with one of the areas. The detector 24 is associated with the area 44, the detector 26 is associated with the area 46 and the detector 28 is associated with the area 48. Similarly, the detector 30, 32, 34, 36, 38 and 40 are respectively associated with the areas 50, 52, 54, 56, 58 and 60.

The site 22 may be a portion of a building such as a hospital floor having several rooms and hallways. Each of the areas schematically shown in FIG. 1 may represent a room or another portion of a location of interest. The site 22 may also be a particular geographic region within which location information is desired. The areas do not necessarily correspond to rooms or other structural limitations on the site 22. In some examples, some rooms may not have any detector within them while others may have multiple detectors. For discussion purposes, each of the areas in FIG. 1 has one detector.

The detectors 24-40 are configured to detect signals from transmitters 62 and 64, for example. As an individual moves through any of the areas of the site 22 carrying or wearing an appropriate transmitter device such as the transmitter 62, the detectors 24-40 receive signals from that transmitter for purposes of providing location information. An object or device having the transmitter 64 situated on it may be moveable within the site 22 into a variety of positions and the detectors 24-40 detect signals from the transmitter 64 for purposes of determining a location of the associated object or device.

One feature of the illustrated example is that the detectors 24-40 and the transmitters 62, 64 are low cost items. In one example, the transmitters 62 and 64 comprise small, inexpensive transmitters. One example includes using low power transmissions to keep the expense of the monitoring system 20 at a minimum and to avoid signaling interference with the operation of other devices within the location 22. In one example, the detectors 24-40 and transmitters 62, 64 are configured to operate in a 2.4 GHz band range.

Utilizing low power, low cost devices provides economic advantages but presents challenges for accurately determining a location of an individual or object of interest. The illustrated example includes a propagation modeling module 66 that automatically determines a propagation model for the areas 44-60 near each of the detectors 24-40. The propagation model allows for accurately making location determinations even though the system 20 relies upon low power, low cost transmitters 62, 64 and low power, low cost detectors 24-40. A location determining module 68 uses information from the propagation model(s) and signals received by the detectors from the transmitters 62, 64 for purposes of locating the transmitters within the location 22.

The example of FIG. 1 includes a database 70 containing information used by the propagation modeling module 66 and the location determining module 68.

Although schematically illustrated as individual modules and distinct from the detectors, the functions of the example propagation modeling module 66, the location determining module 68 and the database 70 may be accomplished using one or more of the detectors having sufficient processing power. The schematic distinction between different components in FIG. 1 is for discussion purposes. Those skilled in the art will realize how to utilize appropriate hardware, software, firmware or a combination of these to satisfy the needs of their particular situation.

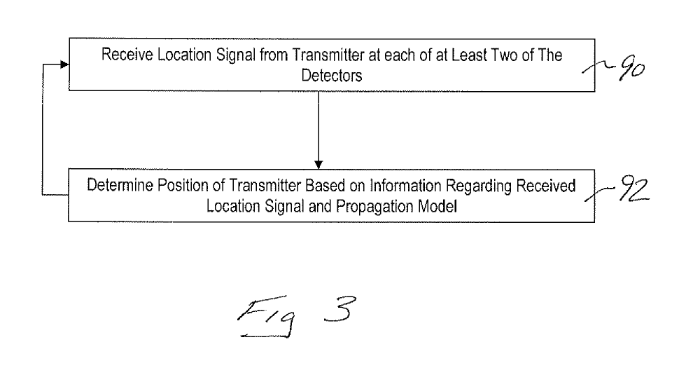

One example approach at determining a propagation model for the site 22 is summarized in the flowchart 80 of FIG. 2. At 82 the detectors 24-40 are arranged at known positions within the site 22. At 84, each of the detectors 24-40 transmit a modeling signal. At 86 each detector 24-40 receives a modeling signal from at least one other of the detectors 24-40. The received modeling signals provide information regarding signal propagation within each area near each of the detectors. For example, the detector 24 will receive a modeling signal from at least the detectors 26, 30 and 32. Each of those signals will be affected by the environment in the area 44 associated with the detector 24. Depending on the position of large objects in that area, any structural features such as walls and individuals present near the detector 24, the characteristics of the received modeling signals at the detector 24 may vary.

The detector 24 determines at least one characteristic of each received modeling signal. In one example, the detector 24 determines at least a received signal strength. In one example, each modeling signal includes information identifying the detector from which it was transmitted. Each detector is at a known position relative to the other detectors. Given the information regarding each received modeling signal, the propagation modeling module 66 is able to determine a propagation model regarding at least the area 44 near the detector 24. Using information regarding how modeling signals are received by the detector 24, which are transmitted at an approximately known power level, allows for the propagation modeling module 66 to automatically determine a propagation model that corresponds to how signals in the area 44 will be affected before they are received by the detector 24.

Communications between the detectors 24-40, the propagation modeling module 66 and the position determining module 68 occur in one example using at least one of a hardwired or wireless link between them. Such links are not illustrated for simplicity.

In one example, each detector provides messages to the other detectors regarding location signals received from a transmitter. When the detector has received the same location signal, the detector is able to obtain a differential between the remote measurements and the measurement of that detector for that location signal. This differential is a strong correlation with the distance between each detector and the other detectors. In one example, each detector maintains a moving average of the RSSI and delay differentials with the neighboring detectors. This information is provided to the position determining module 68 for use in determining a position of a transmitter. The same information is provided to the propagation modeling module 66 for updating the propagation model to respond to any changes in the physical environment in a corresponding area.

In one example, wireless communications between the detectors occur at the same power at which the transmitters of interest are expected to transmit location signals. In another example, the modeling signals from the detectors are transmitted using a different power compared to that used by the transmitters but the propagation model compensates for this.

In one example, the propagation model includes at least a pathloss associated with a signal that propagates through the area 44. The detector 24 reports a received signal strength indicator (RSSI) during the modeling procedure so that the propagation modeling module 66 can determine an approximate pathloss that will occur in the vicinity of the detector 24 for signals transmitted from each of the nearby areas that include a detector.

The same procedure is done for each of the detectors 24-40 using each of the received modeling signals at each of the detectors. The propagation modeling module 66 automatically determines a propagation model for each of the areas 44-60 based on the information regarding the received modeling signals. This is shown at 88 in FIG. 2. In one example, each area has an associated propagation model. One example includes a single propagation model for the entire site 22.

Once the propagation model is developed, that information is stored in the database 70. The propagation model is automatically updated in one example each time that the detectors 24-40 transmit a modeling signal. In one example, the modeling signals are transmitted every thirty seconds and the propagation models are updated responsive to the information regarding the most recently received and reported modeling signals. Automatically, periodically updating the propagation model in this example allows for accounting for changes in signal propagation within any of the areas 44-60 that may occur because of the movement of individuals or objects within any of those areas since the most recent propagation model was developed. This arrangement avoids the drawbacks associated with manually developing signal propagation models and provides a more reliable and accurate locating system that can adapt and respond to changes in the environment around the detectors in an economical and efficient manner.

Having the propagation models allows for accurately locating a low power, low cost transmitter. An example approach for locating a transmitter is shown in FIG. 3. At 90 location signals are received from a transmitter at each of at least two of the detectors 24-40. Considering the example of FIG. 1, at least the detectors 30, 32 and 36 receive a signal transmitted from the transmitter 64. Information regarding the received location signal from the transmitter and the propagation model for the areas associated with the corresponding detectors allows the location determining module 68 to determine at least an approximate position of the transmitter 64 within the site 22. The propagation model for each area indicates how a signal within that area and received by the corresponding detector is affected by the surroundings. The information regarding the location signal received by each of the detectors 30, 32 and 36 will provide information regarding how that signal was affected. That information and the propagation model(s) allow for the location determining module 68 to determine which of the areas 50, 52 or 56 includes the position of the transmitter 64. This is shown at 92 in FIG. 3.

In one example, a detector follows the example procedure of FIGS. 2 and 3 by determining the source of a received signal. For example, the detector checks a numeric address of the signal to determine an identity of the sender. If the sender is another detector, then the signal is a modeling signal requiring the steps in FIG. 2 (e.g., steps 86 and 88). If the sender is a transmitter, then the signal is a location signal and the steps of FIG. 3 (e.g., 90 and 92) are performed based on the propagation model. This example allows for the procedures summarized in FIGS. 2 and 3 to run concurrently.

One feature of the illustrated example is that the position of a transmitter such as the transmitter 64 may be tracked over time. The database 70 in this example includes information regarding a plurality of recent position determinations for each transmitter that is currently being monitored. This allows for tracking the movement of an individual or object if necessary. For example, a path of travel of the transmitter 64 is schematically shown at 94 in FIG. 1. The illustrated example is capable of tracking the position of the transmitter 64 from the area 50, through the areas 56 and 58 to a current location 64′ in the area 60.

Maintaining information regarding recently determined positions of a transmitter not only allows for tracking a path of travel but also is useful for making current position determinations. It is possible to reduce the number of candidate areas (i.e., those areas likely to include the current transmitter location) within which a transmitter likely is located based upon a recently determined position. For example, if the transmitter 64 is determined to be in the area 56 as a most recently determined position and the next location signal transmitted by the transmitter 64 is close enough in time for it to be unreasonable that the transmitter 64 would have traveled a distance great enough to move it more than one area away (e.g., within a few seconds), the areas 44, 46, 48 and 54 may be eliminated from a list of candidate areas within which the transmitter 64 is currently positioned. Such information is useful for more quickly determining the current position of the transmitter 64 based upon a more recently received location signal from that transmitter.

One illustrative simplified example includes developing the propagation model using an estimated signal strength of each received modeling signal at each detector for building up a database regarding relative signal strengths received from the areas associated with each of the detectors from which a modeling signal is received. Then when a transmitter locating signal is received, the strength of that signal at each detector is determined. The information regarding the locating signal strength allows for searching the database to find the closest match to a modeling signal strength. The search for a nearby detector is limited to those that receive the locating signal most strongly. The transmitter position is determined as being near the detector from which a corresponding modeling signal strength was received.

For example, the detector 26 will receive particular modeling signal strengths from each of the detectors 24, 32 and 28 during the modeling phase. A signal from the transmitter 62 received by each of the detectors 24, 26, 28 and 32 will also have a particular signal strength. The locating signal strength should be highest at the detector 26 given that the transmitter 62 is in the area 46 in FIG. 1. This example does not include any modeling information regarding transmissions from within the area 46 received by the detector 26 because there is no other detector in that area during the modeling phase. In this particular situation, the locating signal strength at the detector 26 likely will not have any corresponding signal strength from the model information.

There will be modeling information regarding the detectors 24, 32 and 28. The detector 32, for example, will recognize the location signal strength of the transmitter 62 and report that information to the location determining module 68. The location determining module 68 will then compare the reported location signal strength to propagation model information, which is based on the previously received modeling signal strengths at the detector 32 based on modeling signals from the detectors 24, 26 and 28. The signal strength of the locating signal from the transmitter 62 should have a similar characteristic to the modeling signal recently received from the detector 26 because the transmitter 62 is in the area 46 in the example of FIG. 1. The signal strength received by the detector 32 will have less correspondence to the modeling signal strengths from the detectors 24 and 28, for example. The location determining module in this example concludes that the transmitter 62 is in the area 46.

In another example, assume that the strongest location signal is received by the detector 32 and the second strongest is received by the detector 26. If the observed relative signal strength for all detectors other than 26 and 32 is similar to the database characteristics for modeling signals received from the detector 26 but quite different from those for modeling signals received from the detector 32, then the transmitter 62 is more likely in the area 46 than the area 52.

In each instance, the propagation model information allows the location determining module 68 to make an educated position determination based upon determined signal propagation tendencies within the different areas and information regarding the signal received by at least two of the detectors from a transmitter of interest.

One example propagation model is based on pathloss information. As described above, the modeling signals from the different detectors provide pathloss information between pairs of detectors.

An example pathloss-based propagation model includes pathloss slope σ (in db per decade) and a one meter intercept ψ values as those terms are understood in the art. In one example, at each point in time, each transmitter 62, 64 has position coordinates (x, y, z), an overall attenuation a and pathloss directionality parameters (β, γ). A detector 24-40 has coordinates (X, Y, Z). Each area 44-60 is rectangular in this example and designated by the letter r in the following. Each detector is designated by j or i. The detector in each area has an associated pathloss model with a slope σ db per decade and a one meter intercept ψ. Under these conditions, the pathloss can be described by the following equation:

$${ψ}_{ri} + \frac{{σ}_{ri}}{2} {log}_{10} ( {( X - χ )}^{2} + {( Y - y )}^{2} + {( Z - z )}^{2} ) + α + \frac{β ( X - χ ) + γ ( Y - y )}{\sqrt{{( X - χ )}^{2} + {( Y - y )}^{2}}} \qquad ( 1 )$$

The attenuation α is useful for modeling variations in transmitter transmit power and changes in the surrounding environment such as people or objects near the transmitter or detector that might absorb radio waves. The β and γ parameters are useful for handling antenna directionality and directionalities in local absorption effects. In one example, the detectors are strategically positioned away from obstacles so that there is no contribution to the α, β or γ factors based on the detector.

One example includes using a least squares technique to match equation (1) above against the available data from the signals received at the detectors and to choose the most likely area 44-60 for each transmitter 62, 64. In some examples, the transmitters 62, 64 transmit a location signal approximately once every second. In such examples it is useful to collect data over a time interval T_{c} of five seconds and to assume that the parameters in equation (1) vary linearly. In the following discussion, a ⁻ sign after a variable indicates the value of a parameter near the beginning of the T_{c} time interval and a ⁺ sign after a variable indicates a value of that parameter at the end of the T_{c} time interval (i.e., x⁻, x⁺ are at the beginning and end of T_{c}, respectively).

In one example, a determination is made regarding the slope σᵣᵢ and the intercept ψᵣᵢ. When developing the propagation model as described above, a measurement is taken each time the detectors transmit a modeling signal. In each area (r) 44-60, the detector (j) 24-40 will provide a measurement of at least one other detector's modeling signal. Assuming pathloss reversibility and no detector contributions to α, β and γ, the detector measurements provide values for ψᵣᵢ+ L̅ᵢⱼ σᵣᵢ, where L̅ᵢⱼ is log₁₀ of the known distance between a pair of detectors i and j and r denotes the area that contains the detector j. In the example of FIG. 1 there is only one detector per area so that there is not enough information to compute both ψᵣᵢ and σᵣᵢ. For simplicity, it is reasonable to conclude that the affect of σᵣᵢ is limited by the amount that a detector position in the corresponding area r allows the log₁₀ term from equation (1) above to differ from L̅ᵢⱼ. Accordingly, in one example, σᵣᵢ is set to a reasonable value and the propagation modeling module 66 updates ψᵣᵢ.

Assuming that the actual pathlosses are reversible and that each detector's transmission strength is an amount bᵢ stronger than it should be, the measured pathlosses will differ from the actual pathloss by bᵢ. Accordingly, a relationship between transmit biases of two detectors fits within the following relationship:

PLᵢⱼ−bₗ≈PL_{j.i}−bⱼ (2)

for each pair of detectors i and j. Once each of the detectors has transmitted a modeling signal, it is possible to add a constraint Σᵢbᵢ=0 and solve for the b vector that minimizes the sum of squares of the terms in equation (2). For each pathloss measurement where P L is the pathloss, it is desirable to adjust ψᵣᵢ for the detector j in the corresponding area r. Introducing the term compensates for errors in the measurements and provides the following relationship in which ψᵣᵢ+ L̅ᵢⱼ σᵣᵢ is as described above

PL_{i.j}−bᵢ≈ψᵣᵢ+ L̅ᵢⱼσᵣᵢ (3)

It is not practical in most examples to solve for the b vector by computing results continuously in real time. In one example the terms are collected in an m×m matrix with new terms weighted more heavily. The m×m linear system is solved over the course of the interval between modeling signals from the detectors (e.g., 30 seconds in one example).

Once the b vector from equation (3) is determined, that is used to update the propagation model parameter ψᵣᵢ for any detector i and any area r that includes a detector j, which is not the same as the detector i.

In the example of FIG. 1, there is at most one detector per area and that type of arrangement provides little or no direct information about pathloss slope. One example includes starting with a priori knowledge such as the values of σᵣᵢ should be between 20 and 40 dB per decade and σᵣᵢ should be lower if the area r is long and narrow and the area r has radio-impeding walls. Utilizing a new intercept for each new area reduces the importance of the slope term. This allows for setting most σᵣᵢ values equal to a nominal value. The configuration of a particular area r may allow for using a lower value in some cases. In one example, such values are updated periodically based upon observed conditions. For example, after accounting for reasonable losses associated with walls it is possible to fit a line to the set of all values for (Lᵣᵢ, ψᵣᵢ) and let the slope be a correction to add to the set nominal value for the slope term σ.

When a detector 62, 64 transmits a location signal, some subset Sₖ of the detectors 24-40 will report a determined characteristic of that signal (e.g., the RSS value) to the location determining module 68. In one example, the detectors 24-40 subtract the transmit power of the transmitter (which is known approximately) to get measured pathlosses PLₖᵢ for each i that is a member of the subset Sₖ. For any detector i that is not a member of the subset Sₖ, one example includes assuming that omission from the subset is equivalent to a measurement that the pathloss is greater than the measured pathloss P̅L̅ₖ where the bound P̅L̅ₖ depends on detector sensitivity and on the transmitter transmit power.

One example transmitter locating technique includes determining a pathloss associated with the received locating signal at each of the detectors that received that locating signal. The transmitter position is determined as being within the area near the detector having a propagation model that includes a pathloss most closely corresponding to the determined pathloss associated with the locating signal. In other words, a closest match between a model pathloss and the received pathloss allows for the location determining module 68 to determine the position of the transmitter within a particular area associated with a particular detector.

In one example, determining the transmitter position for each transmitter k includes determining time-varying values where the area r and the parameters x, y, z, α, β and γ that cause equation (1) above to provide the most likely fit to the pathloss measurements associated with the received locating signal. The most likely fit in one example accounts for uncertainty in the pathloss model parameters ψᵣᵢ and σᵣᵢ and avoids excessively large values of α, β and γ along with avoiding rapid changes in x, y, z, α, β or γ.

Given that equation 1 above is non-linear and has several variables, it is not reasonable to expect to minimize it quickly enough to handle thousands of transmitters in hundreds of areas. For situations that have large numbers of transmitters and a large number of areas in which a transmitter may be positioned, one example includes treating the x, y and z variables as unknown but bounded by the parameter of the area r. For each area r and each detector i, upper and lower bounds are computed using the following relationship.

Qᵣᵢ⁻≦log₁₀((X−χ)²+(Y−y)²+(Z−z)²)≦Qᵣᵢ⁺ (4)

This example includes the assumption that (x, y z) is somewhere in the area. Similar (x, y, z) assumptions allow for precomputation of intervals [Uᵣᵢ⁻, Uᵣᵢ⁺] and [Vᵣᵢ⁻, Vᵣᵢ⁺] in which

$$\frac{X - x}{\sqrt{{( X - x )}^{2} + {( Y - y )}^{2}}} and \frac{Y - y}{\sqrt{{( X - x )}^{2} + {( Y - y )}^{2}}} \qquad ( 5 )$$

must lie. One example includes simplifying the calculations by ignoring limitations such as an inability to achieve Qᵣᵢ⁻ and Uᵣᵢ⁻ simultaneously.

The function to be minimized is

$${{λ}_{1} ( {\overline{PL}}_{{ki}^{′}} - {\overline{PL}}_{{ki}^{″}} )}^{2} + {{λ}_{2} ( α - {\overline{α}}_{k} )}^{2} + {λ}_{3} ( {β}^{2} + {γ}^{2} ) + {\sum }_{i} {( {ψ}_{ri} + \frac{{σ}_{ri}}{2} {Q}_{ri}^{\pm } + α + β {U}_{ri}^{\pm } + γ {V}_{ri}^{\pm } - {\overline{PL}}_{ki} )}^{2} \qquad ( 6 )$$

where λ₁, λ₂, λ₃, . . . are constants (e.g., λ₁=10, λ₂=2, λ₃=3, λ₄=5 sec., λ₆=7.5, λ₇=5, λ₈=17, λ₉=256, λ₁₀=2, λ₁₁=0.7), P̅L̅_{ki′} and P̅L̅_{ki″} are described below, and Qᵣᵢ^{±}, Uᵣᵢ^{±} and Vᵣᵢ^{±} mean, “choose the upper or lower bound, whichever makes the quantity to be squared larger near the optimal α, β, γ.” Furthermore, āₖ is a typical α value for a transmitter k, initialized and updated as explained below. Note that the sum should omit any i for which the quantity is zero near the optimal α, β, γ, and any relevant i not in Sₖ should use P̅L̅ₖᵢ= P̅L̅ₖ and require the quantity to be <0.

Selecting an area r for a particular transmitter k in one example includes considering reasonable choices for the area, computing a cost Cₖᵣ for each area by minimizing the equation (6) above as a three-variable least squares problem. In choosing the area in which Cₖᵣ is lowest. One example includes using data from the last few location signal measurements for a particular transmitter k (e.g., all location signal measurements within some time bound) λ₄ seconds of the latest location signal transmission). With this technique, the sum on i becomes a double summation so that P̅L̅ₖᵢ acquires a third index. The combinatorial decisions inherent in using the upper and lower bounds on Q, U and V and the omission of certain detectors i does not allow for a simple linear least squares solution. An unconstrained Newton iteration, however, will converge in one step once α, β, γ get close enough so that a Newton step does not change the combinatorial decisions. Having multiple local minima can be dealt with by insuring that each Newton step reduces the function to be minimized. One example includes using a line search along the Newton step direction trying fractions of the step until the function is reduced (i.e., trying one-half, one-quarter, one-eighth).

The purpose of the λ₁ ( P̅L̅_{ki′}− P̅L̅_{ki″})² is to encourage the chosen area r to be the one that contains the detector i′ that minimizes P̅L̅_{ki′}. If r is that area i″=i′ so that the term is zero; otherwise i″ should be chosen so P̅L̅_{ki′} is the second largest of transmitter k's pathlosses.

Once the area r has been selected, a second optimization over some or all of the variables from the time interval T_{c} is possible. The function to optimize is basically equation (6) with the upper and lower bounds Uᵣᵢ^{±}, Vᵣᵢ^{±} and Qᵣᵢ^{±} replaced by equation (5) and

log₁₀((X−x)²+(Y−y)²+(Z−z)²).

It is based on measured pathlosses P̅L̅ₖᵢₜ at various ages t≦T_{c}, where the sum of equation (6) is over t as well as i, and x, y, z are replaced by

$${x}^{+} + \frac{t ( {x}^{-} - {x}^{+} )}{{T}_{c}} , {y}^{+} + \frac{t ( {y}^{-} - {y}^{+} )}{{T}_{c}} , {z}^{+} + \frac{t ( {z}^{-} - {z}^{+} )}{{T}_{c}} .$$

### Additional Terms

λ₅((x⁻−x⁺)²+(y⁻−y⁺)²)+λ₆(z⁻−z⁺)²

avoid the need for constraints on speed of motion. At the same time enforcing containment within the parameter of the area r does require individual upper and lower bounds on x⁻, x⁺, y⁻, y⁺, z⁻ and z⁺. Given that equation (1) above is non-linear in x, y and z, this example contains a constrained non-linear least squares problem that could conceivably have more than one relative minimum. Detectors i having position coordinates X and Y that are outside of the area within which the detector is believed to be positioned allow equation (1) to be replaced by a linear approximation.

In one example, the least squares minimum is determined using a Newton iteration with a line search. After computing a Newton step and before the line search, one example shortens the step to prevent it from violating a constraint if necessary.

One example includes selecting candidate areas r as the potential position of the transmitter and then choosing the one that minimizes the cost metric described above. Selecting only a modest number of candidate areas is required for efficiency regardless of the number of areas within the site 22. Finding confidence estimates for a small number of candidate areas and tracking these over time is useful in one example. Keeping track of recent position determinations allows for selecting the best possible candidate areas and determining their associated costs beginning with the area within which the most recent position was found. Adding additional areas allows for verifying whether the transmitter has moved to another area. There are a variety of techniques for selecting which of the areas would be included on the list of candidate areas. Given this description, those skilled in the art will be able to choose a candidate area selection technique to meet their particular needs.

Determining the cost Cₖᵣ for each area is useful in this example for ranking possible areas r at a particular time step. Subsequent processing of candidate area choices in one example is accomplished in terms of confidence scores.

Estimating a confidence score for a selected area in one example includes maintaining histograms H₁ and H₂ for the best and second best area costs so that H₁(c) is a probability that the best cost will be less than or equal to (c) and H₂(c) gives the probability for the second best area cost. In one example, H₂ is used to estimate the probability of having a wrong area with a low cost. In other words, if c₁ equals Cₖᵣ₁ and c₂ equals Cₖᵣ₂ are the best two area costs for a particular transmitter k than (1−H₂(c₁)) H₁(c₂) expresses the idea that c₁ is not an accidental choice of the correct area and c₂ is not from the correct area. Alternatively, some j^{th} best cost cⱼ could be associated with the correct area. In such an example, the estimate for that is described as (1−H₂ (cⱼ) H₁ (c₁). Such confidence scores require an accurate second best area cost. Therefore, a stopping criterion for selecting candidate areas is implemented in one example.

One example includes tracking candidate area confidence scores over time and selecting an appropriate threshold before selecting a particular area as the one within which the transmitter is positioned.

Determining that a transmitter is within a particular area provides sufficiently accurate information for many situations. For example, if the site 22 is a hospital floor and the areas 44-60 each correspond to a room on that floor or a storage area, then determining in which area the transmitter is located without exact coordinates of the transmitter provides enough information for purposes of tracking the position or movement of a transmitter on that hospital floor. Of course, if exact coordinates are desirable the above-described techniques can be used in conjunction with a determination algorithm for pinpointing the exact coordinates as may be needed to address the needs of a particular situation.

The disclosed example arrangement and techniques allow for using very inexpensive components while still having high accuracy and reliability for purposes of monitoring one or more individuals or objects in a particular location. The automated way of determining propagation models using signaling communications between the detectors eliminates the costs and unreliability associated with other location technologies and manual modeling techniques.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of determining location information, comprising the steps of:
transmitting a modeling signal from each of a plurality of detectors;
receiving at least one of the transmitted modeling signals at each of plurality of detectors;
determining at least one characteristic of each of the received modeling signals; and
automatically determining a signal propagation model for an area near each of the detectors based on the determined at least one characteristic of each of the received modeling signals, the determined propagation model indicating an effect on a signal received within the corresponding area.

2. The method of claim 1, comprising
periodically transmitting the modeling signal from each of the plurality of detectors; and
responsively updating the automatically determined signal propagation model for the area near each of the detectors.

3. The method of claim 1, wherein at least two of the detectors are at a fixed, known location.

4. The method of claim 1, wherein the signal propagation model for the area near each of the detectors indicates at least an expected pathloss associated with a signal received within the corresponding area.

5. The method of claim 1, wherein the receiving comprises
determining a received signal strength of each received modeling signal at each of the detectors; and
using at least the determined received signal strength and a known transmission power of each of the detectors for automatically determining the signal propagation model for the area near each of the detectors.

6. The method of claim 1, comprising
receiving a locating signal from a transmitter by at least two of the detectors;
determining at least one characteristic of the received locating signal at each of the at least two of the detectors; and
determining a position of the transmitter using information regarding the determined at least one characteristic and the propagation model for the at least two of the detectors.

7. The method of claim 6, comprising
determining a pathloss associated with the received locating signal at each of the at least two of the detectors; and
determining that the transmitter position is within the area indicated by the propagation model including a pathloss that corresponds to the determined pathloss associated with the received locating signal.

8. The method of claim 6, comprising
determining an estimated modeling signal strength of each received modeling signal at each detector;
identifying the one of the detectors that transmitted each received modeling signal with the determined estimated signal strength;
determining a locating signal strength of the received locating signal; and
determining that the transmitter position is near the one of the identified detectors having an estimated modeling signal strength corresponding to the determined locating signal strength.

9. The method of claim 8, comprising
determining that the locating signal strength is higher for the locating signal received by the one of the identified detectors than for others of the detectors.

10. The method of claim 6, comprising
maintaining a series of transmitter position determinations; and
using the series of transmitter position determinations for at least one of
tracking a path of travel of the transmitter over time
or
determining a likely current position based on a most recently determined one of the series of transmitter positions.

11. A device for determining location information, comprising:
a detector configured to
(i) transmit a modeling signal, and
(ii) receive a modeling signal from at least one other detector; and
a propagation modeling module configured to determine a signal propagation model for an area near the detector based on at least one characteristic of each modeling signal received by the detector, the determined propagation model indicating an effect on a signal received within the area.

12. The device of claim 11, wherein the detector periodically transmits the modeling signal and receives other modeling signals and the propagation model determining module responsively updates the automatically determined signal propagation model for the area.

13. The device of claim 11, wherein the detector is one of a plurality of detectors each configured to transmit the modeling signal and to receive the modeling signal from at least one other of the detectors and the propagation modeling module is configured to determine a signal propagation model for a plurality of areas, each of the areas corresponding to at least one of the detectors.

14. The device of claim 11, wherein the signal propagation model for the area indicates at least an expected pathloss associated with a signal received within the area.

15. The device of claim 11, wherein the detector determines a received signal strength of each modeling signal received by the detector;
and wherein the propagation modeling module uses at least the determined received signal strength and a known transmission power of other detectors for automatically determining the signal propagation model for the area.

16. The device of claim 11, comprising
a position determining module configured to determine a position of a transmitter using information regarding at least one characteristic of a locating signal received by the detector and the propagation model.

17. The device of claim 16, wherein the detector determines a pathloss associated with the received locating signal; and
wherein the position determining module determines that the transmitter position is within an area indicated by the propagation model including a pathloss that corresponds to the determined pathloss associated with the received locating signal.

18. The device of claim 16, wherein the detector
determines an estimated modeling signal strength of each received modeling signal;
identifies the one of the other detectors that transmitted each received modeling signal with the determined estimated signal strength;
determines a locating signal strength of the received locating signal; and
wherein the position determining module determines that the transmitter position is near the one of the identified other detectors having an estimated modeling signal strength corresponding to the locating signal strength determined by the detector.

19. The device of claim 18, wherein the position determining module is configured to determine which of the detector or one of the other detectors has a highest associated locating signal strength.

20. The device of claim 16, wherein the position determining module is configured to
maintain a series of transmitter position determinations; and
use the series of transmitter position determinations for at least one of
tracking a path of travel of the transmitter over time
or
determining a likely current position based on a most recently determined one of the series of transmitter positions.
